(19) United States
(12) Patent Application Publication
(10) Pub. No.: US 2026/0332759 A1
(43) Pub. Date: Oct. 22, 2026

(54) CONVOLUTION AND TRANSFORMER BASED LOW COMPLEXITY IN-LOOP FILTER

(71) Applicant: GUANGDONG OPPO MOBILE TELECOMMUNICATIONS CORP., LTD., Dongguan (CN)

(72) Inventors: Cheolkon JUNG, Dongguan (CN); Zhen FENG, Dongguan (CN)

(21) Appl. No.: 19/649,688

(22) Filed: Apr. 16, 2026

Related U.S. Application Data
(63) Continuation of application No. PCT/CN2023/125216, filed on Oct. 18, 2023.

(51) Int. Cl. H04N 19/117; G06N 3/045; G06N 3/0464; H04N 19/82

(52) U.S. Cl. CPC H04N 19/117; G06N 3/045; G06N 3/0464; H04N 19/82

(57) ABSTRACT

Disclosed is a method for encoding via an encoder. The method includes (i) receiving a video sequence by a neural network (NN) based in-loop filter having a convolution-transformer network (CTN) filter; (ii) extracting features from input information, wherein the input information includes a reconstruction picture; (iii) generating a feature map based an output from a shallow feature extraction module of the CTN filter; and (iv) generating a dimension-reduced feature map based on the feature map via a convolution process.

### CROSS-REFERENCE TO RELATED APPLICATION

This application is a Continuation Application of International Application No. PCT/CN2023/125216 filed on Oct. 18, 2023, which is incorporated herein by reference in its entirety.

### TECHNICAL FIELD

The present disclosure relates to imaging and display technologies. More particularly, video compression schemes including a convolution and transformer based in-loop filter are disclosed herein.

### BACKGROUND

Existing video compression methods, such as High Efficiency Video Coding (HEVC) and Versatile Video Coding (VVC) perform blocking and quantization processes when encoding. These processes result in irreversible information loss and various compression artifacts (such as blocking, blurring, banding artifacts, etc.) and distortion. To reduce such artifacts and distortion caused by compression, VVC uses an in-loop filter module to address the foregoing issue. Despite the effectiveness of the in-loop filter in VVC for compression artifact removal, the existing filters have limited performance when dealing with the complicated compression artifacts. Although there are certain methods trying to reduce these compression artifacts, they are not efficient and require significant computing resources. Therefore, it is advantageous to have an improved system and method to address the foregoing needs.

### SUMMARY

Based on residual Convolutional Neural Network (CNN) and transformer, the present disclosure provides a NN based in-loop filter for VVC, named “ConvTransNet.”

Though the following systems and methods are described in relation to video processing, in some embodiments, the systems and methods may be used for other image processing systems and methods. The present disclosure also provides a framework/network that can be trained by deep learning and/or artificial intelligent schemes.

The NN based in-loop filter in the present disclosure (“ConvTransNet”) is based on residual CNN and transformer blocks (RCTB). The ConvTransNet framework includes three main portions: (1) shallow feature extraction portion; (2) deep feature extraction portion, and (3) reconstruction portion. Embodiments of these three portions are discussed in detail with reference to FIG. 2 and FIG. 3.

In the shallow feature extraction portion, the ConvTransNet framework adopts a parallel structure to extract features from various input sources (e.g., reconstruction feedback, partition, prediction, quantization parameter (QP) map, etc.). Depending on the richness of the input information, distinct sets of feature maps can be obtained, and then a “3×3” convolutional subsampling can be used so as to reduce computational complexity.

The deep feature extraction portion is the core component of the ConvTransNet framework. The deep feature extraction portion includes two parts. The first part is a backbone network composed of various RCTB modules with a skip connection. The skip connect ensures information transfer. The second part is a pyramid structure to extract multi-scale features from coarse to fine. The forgoing arrangement provides rich auxiliary information for the backbone network (the first part).

The reconstruction portion includes one “3×3” convolution layer and one pixel-shuffle layer. These layers are used to reconstruct the images/pictures based on the feature data processed by the shallow feature extraction portion and the deep feature extraction portion. To further enhance the quality of the reconstruction, a long skip connection is used to incorporate residual input images/pictures. In some embodiments, one or more of the foregoing portions and parts can be designed according to various components, such as luma components and/or chroma components.

In some embodiments, the methods discussed herein for a “picture” or a “frame” can be applied to a portion or a region of the “picture” or the “frame.” For example, the methods disclosed herein can be applied to a sub-picture, a region of a picture (e.g., showing an object of interest), etc.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings.

FIG. 1 is a schematic diagram illustrating a system (in VVC structure) having a ConvTransNet (CTN) filter in accordance with one or more implementations of the present disclosure.

FIG. 2 is a schematic diagram illustrating a CTN filter in accordance with one or more implementations of the present disclosure.

FIG. 3 is a schematic diagram illustrating the CTN filter in accordance with one or more implementations of the present disclosure.

FIG. 4 is a schematic diagram illustrating a Residual CNN and Transformer Block (RCTB) in accordance with one or more implementations of the present disclosure.

FIG. 5 is a schematic diagram illustrating a Residual Multi-Scale Attention (RMSA) block in accordance with one or more implementations of the present disclosure.

FIG. 6 is a schematic diagram of a wireless communication system in accordance with one or more implementations of the present disclosure.

FIG. 7 is a schematic block diagram of a terminal device in accordance with one or more implementations of the present disclosure.

FIG. 8 is a schematic block diagram of an electronic device in accordance with one or more implementations of the present disclosure.

FIG. 9 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings.

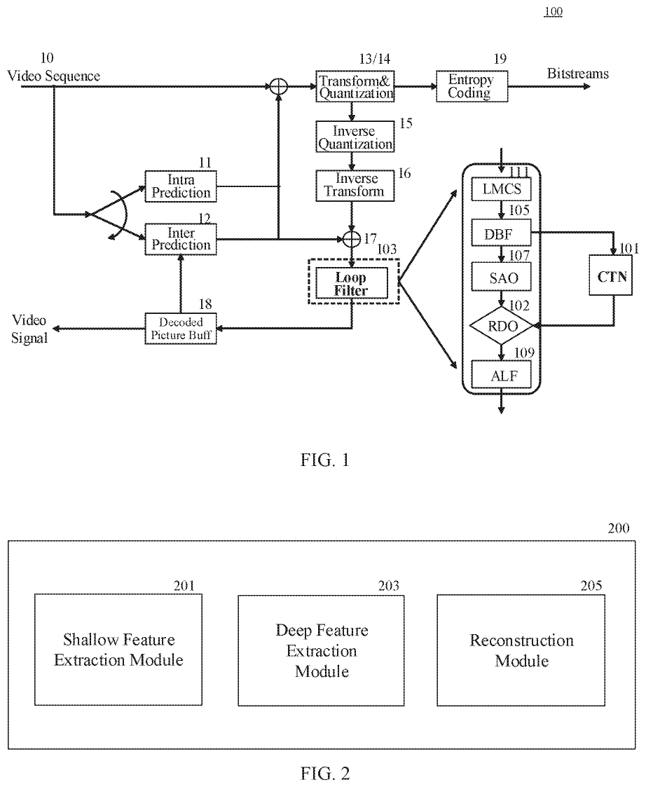

FIG. 1 is a schematic diagram illustrating a system 100 (in a VVC structure) having a CTN filter 101 (in an in-loop filter 103) in accordance with one or more implementations of the present disclosure. The system 100 is configured in accordance with the VVC structure.

The system 100 includes a video sequence 10 as input to an intra prediction module 11 and/or an inter prediction module 12. The output of the intra prediction module 11 and the inter prediction module 12 can be directed to a transform module 13. The output of the transform module 13 can be quantized by a quantization module 14. The output of the quantization module 14 can then be directed to an inverse quantization module 15 and an inverse transform module 16. Generally speaking, with an increase of Quantization Parameter (QP), compression artifacts become more and more significant/serious (i.e., image qualities get worse).

As shown in FIG. 1, at an adder 17, the output of the intra prediction module 11 and the inter prediction module 12 can be added with the output of the inverse transform module 16. The added result can then be directed to the in-loop filter 103. The output of the in-loop filter 103 can then be directed to a decoded picture buffer 18 for further processes by the inter prediction module 12.

The system 100 uses loop filters to suppress compression artifacts and reduce distortion. These loop filters include a deblocking filter (DBF) 105, a sample adaptive offset (SAO) filter 107, and an adaptive loop filter (ALF) 109. As shown in FIG. 1, the CTN filter 101 is connected in parallel with the SAO filter 107, a rate-distortion optimization (RDO) 102 is used to select the best CTU as an output, and finally output through the ALF 109. In some embodiments, the CTN filter 101 can be positioned at other positions, e.g., replace the DBF filter 105 and the SAO filter 107 filter with the CTN filter 101 or embed the CTN filter 101 between the SAO filter 105 and the ALF 109. In some embodiments, the in-loop filter 103 is not required to include all of the filters shown in FIG. 1.

In some embodiments, the DBF 105 and the SAO filter 107 are two filters designed to reduce artifacts caused by an encoding process. The DBF 105 focuses on visual artifacts at block boundaries. The SAO filter 107 complementarily reduces artifacts that may arise from quantization of transform coefficients within blocks. The ALF 109 can enhance an adaptive filter of a reconstructed signal, reducing a mean square error (MSE) between the original and reconstructed samples by using a Wiener-based adaptive filter. As shown, the in-loop filter 103 can also include an LMCS (luma mapping with chroma scaling) filter 111. The LMCS filter 111 is configured to (1) map input luma code values to a new set of code values for use inside a coding loop; and 2) scale chroma residue values according to the luma code values.

FIG. 2 is a schematic diagram illustrating a CTN filter 200 in accordance with one or more implementations of the present disclosure. As shown, the CTN filter 200 includes a shallow feature extraction module 201, a deep feature extraction module 203, and a reconstruction module 205. In some embodiments, one or more of these modules can be designed according to various components (such as luma components and/or chroma components) as well as picture frames (e.g., I-Slice, B slice, etc.).

The shallow feature extraction module 201 is configured to extract shallow features from a video sequence. More particularly, the shallow feature extraction module 201 uses a parallel structure to extract features from various input sources, including, a reconstruction feedback loop, a partition map, a prediction map, a quantization parameter (QP) map. In some embodiments, various combinations of input sources can be selected depending on the richness of the input information. The shallow feature extraction module 201 includes a convolutional subsampling layer (e.g., a “3×3” convolutional subsampling layer) for each input source so as to reduce computational complexity. The shallow feature extraction module 201 can then concatenate the processed data from various sources and then perform a further convolution (e.g., by a “1×1” convolutional layer) as well as a down sampling process such that the data can be further processed by the deep feature extraction module 203.

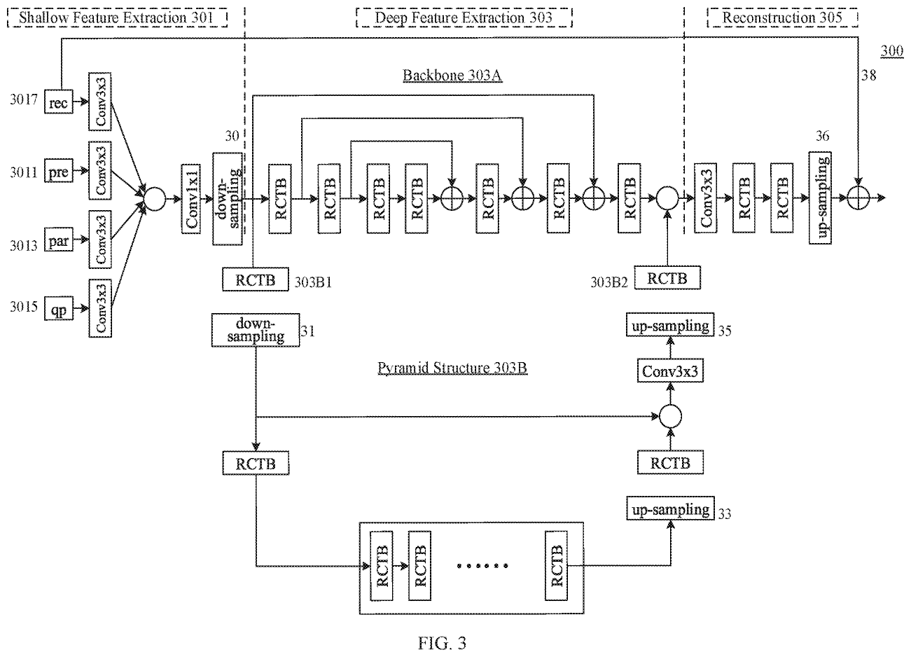

The deep feature extraction module 203 includes two parts, a backbone network and a pyramid structure. The backbone network includes various RCTB modules (e.g., 7 RCTBs) with a skip connection (e.g., inputs and outputs of these RCTBs are interconnected along a main, backbone process, as shown in FIG. 3). The skip connect ensures information transfer among these RCTBs. The pyramid structure is configured to extract multi-scale features from coarse to fine. The forgoing arrangement provides rich auxiliary information for the backbone network.

The reconstruction module 205 is configured to reconstruct the images/pictures processed by the shallow feature extraction portion and the deep feature extraction portion. In some embodiments, the reconstruction module 205 can include one “3×3” convolution layer and one pixel-shuffle layer. The foregoing layers are used to reconstruct the images/pictures processed by the shallow feature extraction portion and the deep feature extraction portion. In some embodiments, the reconstruction module 205 can have different sizes of convolution layers and multiple pixel-shuffle layers, depending on various designs. The reconstruction module 205 can also have a long skip connection for incorporating residual input images/pictures, so as to enhance reconstruction quality. In some embodiments, for example, the pixel-shuffle layer can be used to up-sample dimension-reduced features to obtain a multi-channel residual map. The obtained residual map can be added to the reconstruction frame/picture of the input information, thereby enhancing image quality of the reconstruction frame/picture.

FIG. 3 is a schematic diagram illustrating a CTN filter 300 in accordance with one or more implementations of the present disclosure. As shown in FIG. 3, the CTN filter 300 includes a shallow feature extraction portion 301, a deep feature extraction portion 303, and a reconstruction portion 305.

The shallow feature extraction portion 301 receives input information from various sources such as a prediction frame/picture 3011, a partition frame/picture 3013, and a QP map 3015. The shallow feature extraction portion 301 also receives a reconstruction frame/picture 3017 as input. In some embodiments, the prediction frame/picture 3011 can include prediction information of a current frame/picture and can be generated by a neighboring frame/picture. In some implementations, the partition frame/picture 3013 can include block information of the current frame/picture. The QP map 3015 can represent quantization information used by the current frame/picture.

As shown in FIG. 3, the shallow feature extraction portion 201 includes a convolutional subsampling layer (e.g., a “3×3” convolutional subsampling layer) for each input source (e.g., the prediction frame/picture 3011, the partition frame/picture 3013, the QP map 3015, and the reconstruction frame/picture 3017) so as to reduce computational complexity. The shallow feature extraction portion 301 then concatenates the processed data and then performs a further convolution (e.g., by a “1×1” convolutional layer). A down-sampling process 30 is further processed such that the processed data can be used as input to the deep feature extraction portion 303.

As shown, the deep feature extraction portion 303 includes two parts, a backbone structure 303A and a pyramid structure 303B. The backbone structure 303A includes various RCTB modules (e.g., 7 RCTBs) with a skip connection (e.g., inputs and outputs of these RCTBs are interconnected along a main, backbone process. The skip connect ensures information transfer among these RCTBs.

The pyramid structure 303B is configured to extract multi-scale features from coarse to fine. The pyramid structure 303B is connected to the backbone structure 303A via a down-sampling RCTB 303B1 and an up-sampling RCTB 303B2. The pyramid structure 303B first performs a down-sampling process 31, and then multiple RCTBs are introduced for further processing. Then a first up-sampling process 33 is performed. The processed data is then converged and is directed to a convolution layer (e.g., “3×3”). Then a second up-sampling process 35 is performed. The processed data is then directed back to the backbone structure 303A. The pyramid structure 303B provides auxiliary information for the backbone structure 303A.

As shown in FIG. 3, the reconstruction portion 305 then directs the processed data from the deep feature extraction portion 303 to a convolution layer (e.g., “3×3”), and then two RCTBs. An up-sampling process 36 is then performed. The reconstruction portion 305 reconstruct the images/pictures processed by the shallow feature extraction portion 301 and the deep feature extraction portion 303. In some embodiments, the reconstruction portion 305 can include a pixel-shuffle layer. In some embodiments, the reconstruction portion 305 can have different sizes (e.g., kernels) of convolution layers and multiple pixel-shuffle layers, depending on various designs. The reconstruction portion 305 has a long skip connection 38 for incorporating residual input images/pictures, so as to enhance reconstruction quality.

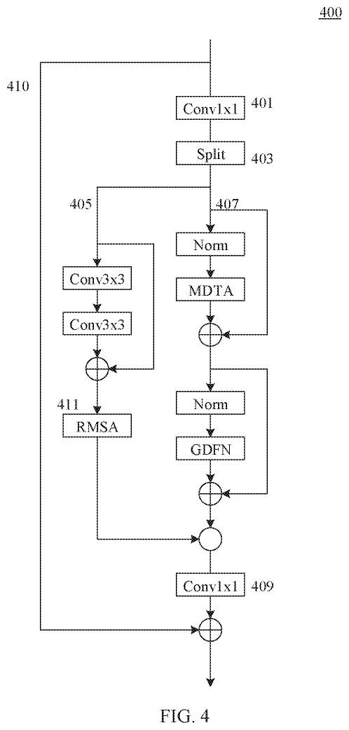

FIG. 4 is a schematic diagram illustrating a Residual CNN and Transformer Block (RCTB) 400 in accordance with one or more implementations of the present disclosure. As shown in FIG. 4, the RCTB 400 includes a “1×1” convolution layer 401 and a split function block 403. The split function block 403 separates the process into a convolution path 405 and a transformer path 407. The convolution path 405 and the transformer path 407 are combined in parallel so as to capture local and global information across different scales. The convolution path 405 and the transformer path 407 are later merged and then are directed to another “1×1” convolution layer 409.

To reduce the complexity of the RCTB 400, an input tensor (e.g., B, C, H, W) is separate into two segments: a first segment (B, C/2, H, W) and a second segment (B, C/2, H, W). Parameter “B” indicates a batch size, parameter “C” indicates a channel, parameter “H” indicates a height, and parameter “W” indicates a width. The first segment is directed to convolution path 405 and the second segment is directed to the transformer path 407.

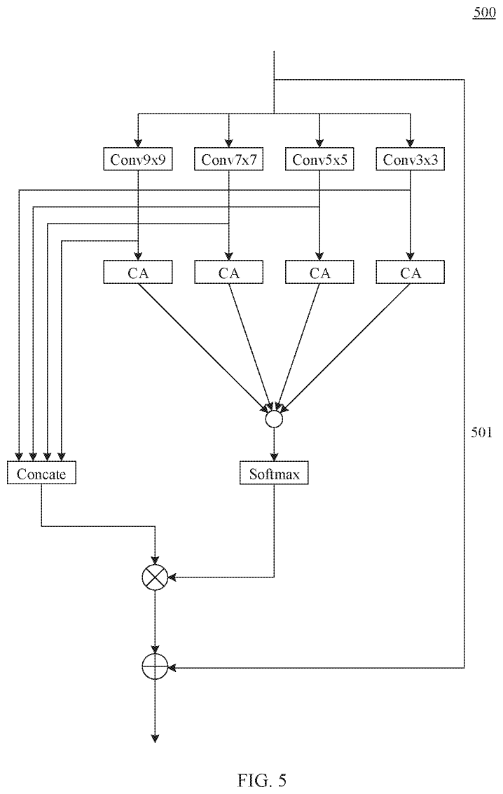

In the convolution path 405, the first segment (B, C/2, H, W) is processed through a residual structure network. The residual network includes two “3×3” convolution layers and a residual multi-scale attention (RMSA) module 411. Embodiments of the RMSA module 411 are discussed in detail with reference to FIG. 5.

In the transformer path 407, a network architecture introduced in “Restormer” (Efficient Transformer for High-Resolution Image Restoration) is implemented. As also shown, the transformer path 407 includes a Multi-DConv-Head Transposed Attention (MDTA) component and a gated-Dconv feed-forward network (GDFN component and corresponding normalization blocks (“Norm”).

Then the two paths 405, 407 are merged and then directed to the convolution layer 409. A long skip connection 410 is used to bolster the performance of the RCTB 400 and enhance its generalization capabilities. The forgoing arrangement results in a more comprehensive and enriched image representation.

FIG. 5 is a schematic diagram illustrating a Residual Multi-Scale Attention (RMSA) block 500 in accordance with one or more implementations of the present disclosure. As shown in FIG. 5, an input of the RMSA block 500 is divided into four groups by channels. Each group is convolved with different convolution kernel sizes to obtain receptive fields of different scales and extract information of different scales. In the illustrated embodiments, there are “3×3,” “5×5,” “7×7,” and “9×9” convolution layers. In other embodiments, there can be other types of convolution layers. The four groups can then be combined or concatenated (at “Concate” in FIG. 5).

The RMSA block 500 also includes multiple channel attention (CA) modules. These CA modules are configured to obtain a weighting value for each group. A normalized exponential function (such as “Softmax” shown in FIG. 5) can then be used to normalize the weighting values of the four groups. By this arrangement, the RMSA block 500 enables an operator to select which feature to focus on (e.g., high frequency features or low frequency features) by adjusting the weighting values of the groups. This configuration improves adaptability to intrinsic and diverse image attributes. The grouping arrangement with various types of convolutional kernels can effectively reduce the complexity of computation and thus enhance overall system efficiency. The RMSA block 500 also have an extensive skip connection 501 to boost the performance of the RMSA 500 and improve its generalization capabilities.

In some embodiments, the channel attention (CA) module can include an intensity channel attention module and a contrast channel attention module. In some embodiments, the intensity channel attention module can be configured to extract a weight of each channel through global average pooling, channel compression, and expansion processes. Then the extracted weight can be multiplied by the feature map so as to obtain a channel attention map.

In some embodiments, loss functions can be used to train the CTN filter discussed herein. For example, L1 loss and L2 loss can be used to train the CTN filter. The loss function for luma and chroma model can be expressed as follows:

L₁(I_{out, I}_{_{gt}}) Epoch<30

L2(I_{out, I}_{_{gt}}) 30≤Epoch<50 Equation (a)

“Loss” indicates “L1 loss” or “L2 loss” function. In some embodiments, L1 loss can used in the first and mid-training period, and “L2 loss” can be used in the late training period. Parameter “Epoch” indicates how many times training data is used to update the weights of a training model.

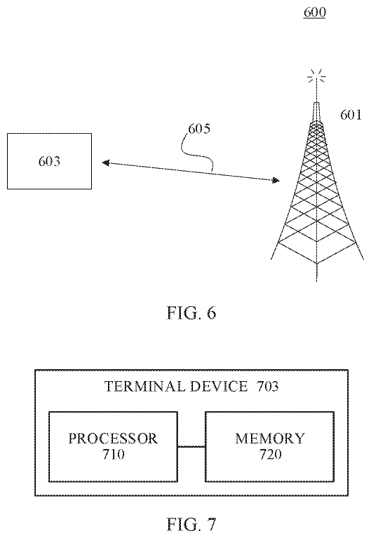

FIG. 6 is a schematic diagram of a wireless communication system 600 in accordance with one or more implementations of the present disclosure. The wireless communication system 600 can implement the framework discussed herein. As shown in FIG. 6, the wireless communications system 600 can include a network device (or base station) 601. Examples of the network device 601 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 601 can include a relay station, an access point, an in-vehicle device, a wearable device, and the like. The network device 601 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 6, the wireless communications system 600 also includes a terminal device 603. The terminal device 603 can be an end-user device configured to facilitate wireless communication. The terminal device 603 can be configured to wirelessly connect to the network device 601 (via, e.g., via a wireless channel 605) according to one or more corresponding communication protocols/standards. The terminal device 603 may be mobile or fixed. The terminal device 603 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 603 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like.

For illustrative purposes, FIG. 6 illustrates only one network device 601 and one terminal device 603 in the wireless communications system 600. However, in some instances, the wireless communications system 600 can include additional network device 601 and/or terminal device 603.

FIG. 7 is a schematic block diagram of a terminal device 703 (e.g., which can implement the methods discussed herein) in accordance with one or more implementations of the present disclosure. As shown, the terminal device 703 includes a processor 710 and a memory 720. The processor 710 can be configured to implement instructions that correspond to the methods discussed herein and/or other aspects of the implementations described above. It should be understood that the processor 710 in the implementations of this technology may be an integrated circuit chip and has a signal processing capability. During implementation, the steps in the foregoing method may be implemented by using an integrated logic circuit of hardware in the processor 710 or an instruction in the form of software. The processor 710 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 710 may be a microprocessor, or the processor 710 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 720, and the processor 710 reads information in the memory 720 and completes the steps in the foregoing methods in combination with the hardware thereof.

It may be understood that the memory 720 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

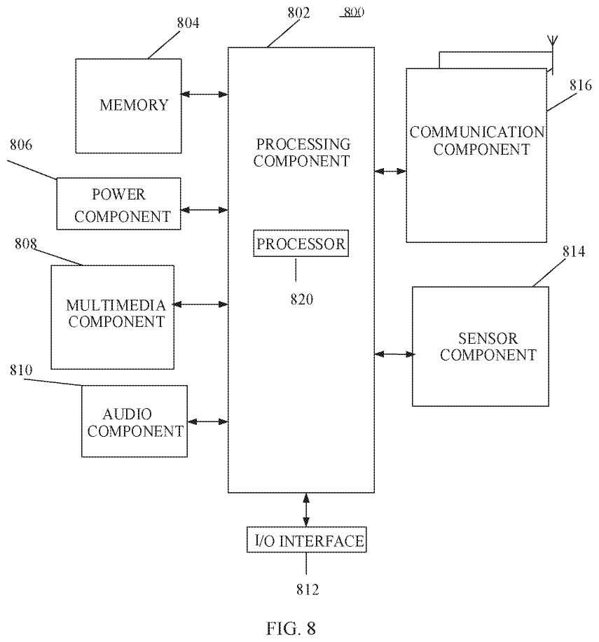

FIG. 8 is a schematic block diagram of an electronic device 800 in accordance with one or more implementations of the present disclosure. The electronic device 800 may include one or more following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device. Examples of such data include instructions for any application programs or methods operated on the electronic device, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device. The power component 806 may include a power management system, one or more power supplies, and other components associated with generation, management and distribution of power for the electronic device.

The multimedia component 808 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 808 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 may include a Microphone (MIC), and the MIC is configured to receive an external audio signal when the electronic device is in the operation mode, such as a call mode, a recording mode and a voice recognition mode. The received audio signal may further be stored in the memory 804 or sent through the communication component 816. In some embodiments, the audio component 810 further may include a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the electronic device. For instance, the sensor component 814 may detect an on/off status of the electronic device and relative positioning of components, such as a display and small keyboard of the electronic device, and the sensor component 814 may further detect a change in a position of the electronic device or a component of the electronic device, presence or absence of contact between the user and the electronic device, orientation or acceleration/deceleration of the electronic device and a change in temperature of the electronic device. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 816 receives a broadcast signal or broadcast associated information from an external broadcast management system through a broadcast channel. In an exemplary embodiment, the communication component 816 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 810 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 804 including an instruction, and the instruction may be executed by the processing component 802 of the electronic device 800 to implement the methods discussed herein. For example, the non-transitory computer-readable storage medium may be a ROM, a Random Access Memory (RAM), a Compact Disc Read-Only Memory (CD-ROM), a magnetic tape, a floppy disc, an optical data storage device and the like.

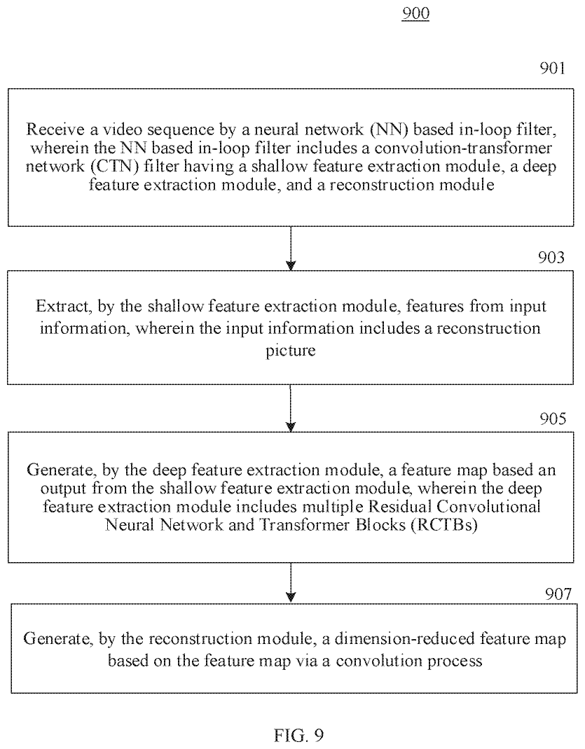

FIG. 9 is a flowchart of a method in accordance with one or more implementations of the present disclosure. The method 900 can be implemented by a system or an apparatus (such as a system or an apparatus having the CTN filter discussed herein). The method 900 is for enhancing image qualities. The method 900 includes, at block 901, receiving a video sequence by a neural network (NN) based in-loop filter. The NN based in-loop filter includes a convolution-transformer network (CTN) filter has a shallow feature extraction module, a deep feature extraction module, and a reconstruction module. Embodiments of the CTN filter are discussed in detail with reference to FIG. 2 and FIG. 3.

At block 903, the method 900 continues by extracting, by the shallow feature extraction module, features from input information. The input information includes a reconstruction picture. In some embodiments, the input information further includes a partition picture, a quantization parameter (QP) map, and/or a prediction picture.

At block 905, the method 900 continues by generating, by the deep feature extraction module, a feature map based an output from the shallow feature extraction module. The deep feature extraction module includes multiple Residual Convolutional Neural Network and Transformer Blocks (RCTBs). Embodiments of the RCTB are discussed in detail with reference to FIG. 4.

In some embodiments, the shallow feature extraction module includes one or more “3×3” convolution layers, a concatenate layer, and a “1×1” convolution layer. In some embodiments, the deep feature extraction module include a backbone structure and a pyramid structure. In some embodiments, the backbone structure includes the multiple RCTBs in series, and wherein the multiple RCTBs is connected via a skip connection. In some embodiments, the pyramid structure is connected to the backbone structure via a down-sampling RCTB and an up-sampling RCTB. In some embodiments, the pyramid structure includes the multiple RCTBs.

In some embodiments, the pyramid structure includes a “3×3” convolution layer. In some embodiments, each of the multiple RCTBs includes a “1×1” convolution layer and a split function block. In some embodiments, each of the multiple RCTBs includes a convolution path and a transformer path, and the convolution path and the transformer path are in parallel. In some embodiments, the convolution path is configured to process a first segment of channels and the transformer path is configured to process a second segment of channels. In some embodiments, the convolution path includes a residual multi-scale attention (RMSA) module. In some embodiments, the RMSA module includes four groups of channels, and the four groups of channels are processed by convolution layers with different dimensions. In some embodiments, the RMSA module includes multiple channel attention (CA) modules. Embodiments of the RMSA module are discussed in detail with reference to FIG. 5.

At block 907, the method 900 continues by generating, by the reconstruction module, a dimension-reduced feature map based on the feature map via a convolution process.

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer-or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the present disclosure is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the present disclosure are presented below in certain claim forms, the applicant contemplates the various aspects of the present disclosure in any number of claim forms. Accordingly, the applicant reserves the right to pursue additional claims after filing this application to pursue such additional claim forms, in either this application or in a continuing application. What is claim ed is:

1. A method for encoding via an encoder, comprising:
receiving a video sequence by a neural network (NN) based in-loop filter, wherein the NN based in-loop filter includes a convolution-transformer network (CTN) filter having a shallow feature extraction module, a deep feature extraction module, and a reconstruction module;
extracting, by the shallow feature extraction module, features from input information, wherein the input information includes a reconstruction picture;
generating, by the deep feature extraction module, a feature map based an output from the shallow feature extraction module, wherein the deep feature extraction module includes multiple Residual Convolutional Neural Network and Transformer Blocks (RCTBs); and
generating, by the reconstruction module, a dimension-reduced feature map based on the feature map via a convolution process.

2. The method of claim 1, wherein the input information further includes a partition picture.

3. The method of claim 1, wherein the input information further includes a quantization parameter (QP) map.

4. The method of claim 1, wherein the input information further includes a prediction picture.

5. The method of claim 1, wherein the shallow feature extraction module includes one or more “3×3” convolution layers, a concatenate layer, and a “1×1” convolution layer.

6. The method of claim 1, wherein the deep feature extraction module include a backbone structure and a pyramid structure.

7. The method of claim 6, wherein the backbone structure includes the multiple RCTBs in series, and wherein the multiple RCTBs is connected via a skip connection.

8. The method of claim 6, wherein the pyramid structure is connected to the backbone structure via a down-sampling RCTB and an up-sampling RCTB.

9. The method of claim 6, wherein the pyramid structure includes the multiple RCTBs.

10. The method of claim 6, wherein the pyramid structure includes a “3×3” convolution layer.

11. The method of claim 1, wherein each of the multiple RCTBs includes a “1×1” convolution layer and a split function block.

12. The method of claim 1, wherein each of the multiple RCTBs includes a convolution path and a transformer path, and wherein the convolution path and the transformer path are in parallel.

13. The method of claim 12, wherein the convolution path is configured to process a first segment of channels and the transformer path is configured to process a second segment of channels.

14. The method of claim 12, wherein the convolution path includes a residual multi-scale attention (RMSA) module.

15. The method of claim 14, wherein the RMSA module includes four groups of channels, and wherein the four groups of channels are processed by convolution layers with different dimensions.

16. The method of claim 14, wherein the RMSA module includes multiple channel attention (CA) modules.

17. A method for decoding via a decoder, comprising:
extracting, by a shallow feature extraction module, features from a reconstruction picture;
generating, by a deep feature extraction module, a feature map based on the features extracted from the reconstruction picture, wherein the deep feature extraction module includes multiple Residual Convolutional Neural Network and Transformer Blocks (RCTBs); and
generating, by a reconstruction module, a dimension-reduced feature map based on the feature map via a convolution process.

18. The method of claim 17, wherein each of the multiple RCTBs includes a convolution path and a transformer path, wherein the convolution path includes a residual multi-scale attention (RMSA) module, wherein the RMSA module includes four groups of channels, wherein the four groups of channels are processed by convolution layers with different dimensions, and wherein the RMSA module includes multiple channel attention (CA) modules.

19. A system for encoding, comprising:
a processor; and
a memory configured to store instructions, when executed by the processor, to:
receive a video sequence by a neural network (NN) based in-loop filter, wherein the NN based in-loop filter includes a convolution-transformer network (CTN) filter having a shallow feature extraction module, a deep feature extraction module, and a reconstruction module;
extract, by the shallow feature extraction module, features from input information, wherein the input information includes a reconstruction picture;
generate, by the deep feature extraction module, a feature map based an output from the shallow feature extraction module, wherein the deep feature extraction module includes multiple Residual Convolutional Neural Network and Transformer Blocks (RCTBs); and
generate, by the reconstruction module, a dimension-reduced feature map based on the feature map via a convolution process.

20. The system of claim 19, wherein each of the multiple RCTBs includes a convolution path and a transformer path, wherein the convolution path includes a residual multi-scale attention (RMSA) module, wherein the RMSA module includes four groups of channels, wherein the four groups of channels are processed by convolution layers with different dimensions, and wherein the RMSA module includes multiple channel attention (CA) modules.
